(19) United States
(12) Patent Application Publication
(10) Pub. No.: US 2009/0191316 A1
(43) Pub. Date: Jul. 30, 2009

(54) RETRACTABLE CANDY HOLDER

(76) Inventors: Marco Perry, Brooklyn, NY (US); Todd Brunner, Brooklyn, NY (US); James J. Best, Hewitt, NJ (US)

Correspondence Address: DARBY & DARBY P.C., P.O. BOX 770, Church Street Station, New York, NY, 10008-0770, US

(21) Appl. No.: 12/022,614

(22) Filed: Jan. 30, 2008

(51) Int. Cl. A23G 3/56; B65D 83/00; B65D 85/00

(52) U.S. Cl. 426/115; 220/811; 224/191

(57) ABSTRACT

The present invention is a holder for a confectionary product. The holder has two sections that enclose the confectionary product when in the closed position. The holder may be opened by sliding the two sections apart and then pivoting one of the sections relative to the other one hundred and eighty degrees to intermesh and thereby form a handle for holding the confectionary product during consumption by a user.

### BACKGROUND OF THE INVENTION

Confectionary products take many forms and have a variety of different packaging. Often, the packaging itself is the only distinguishing feature between two competing products. In other instances, the packaging provides benefits to the user that are lacking in competing products. In many instances, the packaging of the product provides as much enjoyment to the user as the confectionary itself.

One type of confectionary is a hard candy that is attached to a holder. An example of this is a lollipop, which is a type of confectionery consisting mainly of hardened, flavored sucrose with corn syrup mounted on a stick and intended for sucking or licking. Lollipops are available in many flavors and shapes. When eating a confectionary hard candy such as a lollipop, many children will partially consume the hard candy but then either put it down or ask someone to hold it for them so that it can be finished at a later time. The problem is that the partially consumed hard candy is very sticky. It will at a minimum leave a residue on whatever surface it is placed on, will likely be stuck to any such surface and will stick to any debris it comes in contact with. This leads to inconvenience and/or an unsanitary product if the child continues to consume the hard candy at a later time.

There have been attempts at solving this problem. As one example, in (U.S. Pat. No. 6,120,816, a holder for a lollipop is disclosed in which a candy holder is pivotally connected to a housing. In the closed position, the candy holder 8 with attached candy C is contained within housing 14 and cover 80, as shown in FIGS. 3 through 5. To open the candy holder, a user presses release button 10 (FIG. 2) or 70 (FIGS. 3 to 5) which opens cover 80 and permits a spring mechanism to cause candy holder 8 to swing into the open position. Cover 80 then moves back to the closed position so that the user can hold the candy for consumption. In this configuration, cover 80 and the candy holder are pivotally mounted to the housing, at opposite ends. The drawback of this device is the complexity of the mechanism, which requires a spring biasing element connected to a release element, and that to close the mechanism a user must push the candy and/or holder pack into the cavity. This leads to contamination of the confectionary product.

### BRIEF SUMMARY OF THE INVENTION

The present invention is directed to a holder for confectionary products. In one aspect of the invention, a hard candy is attached to a mounting piece. The mounting piece may be attached to a two piece housing, with one piece of the housing slideably attached to the mounting piece and the second piece of the housing pivotably attached to the mounting piece. The two pieces of the housing intermesh in a number of ways. In one slide and pivot position, the two housing parts interlock to enclose the hard candy attached to the mounting piece, thereby protecting it from sticking to a surface that the candy holder is placed on and protecting it from contacting any unwanted debris. In a second slide and pivot position, the two housing parts again intermesh, but this time to form a handle portion that can be held by the user when consuming the hard candy.

In one aspect of the invention, the second part of the housing is pivotably connected to the mounting piece through elongated slots in the first part of the housing. The connection of the second part of the housing to the mounting piece acts as a guide for the slideable aspect of the first part of the housing relative to the mounting piece. In another aspect of the invention, the second part of the housing may have guide portions that mesh with the elongated slots so as to provide a guide for the second pivot part of the housing with respect to the first part of the housing.

Another aspect of the invention is that the holder can have a slot to which a strap can be attached so that a user may, for example, wear the holder around their neck or wrist.

These and other advantages and features will become apparent from the detailed description of the invention that follows.

### BRIEF DESCRIPTION OF THE DRAWINGS

FIG. 1 is a perspective view of the confectionary holder;

FIG. 2 is a front view of the confectionary holder in the closed position;

FIG. 3 is a side perspective view of the confectionary holder in the closed position;

FIG. 4 is a top view of the confectionary holder in the closed position;

FIG. 5 is a bottom view of the confectionary holder in the closed position;

FIG. 6 is a front view of the confectionary holder in a partially opened position;

FIG. 7 is a front view of the confectionary holder in a partially opened position;

FIG. 8 is a perspective view of the confectionary holder in a partially opened position; and

FIG. 9 is a cross sectional view of the confectionary holder in the open position.

### DETAILED DESCRIPTION OF THE INVENTION

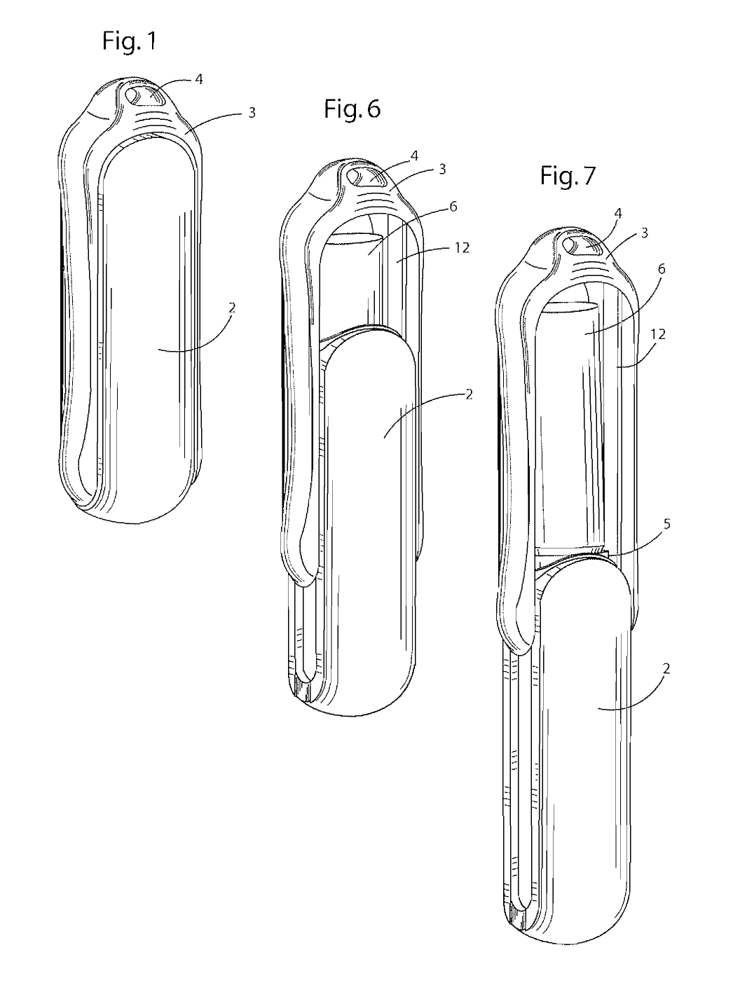

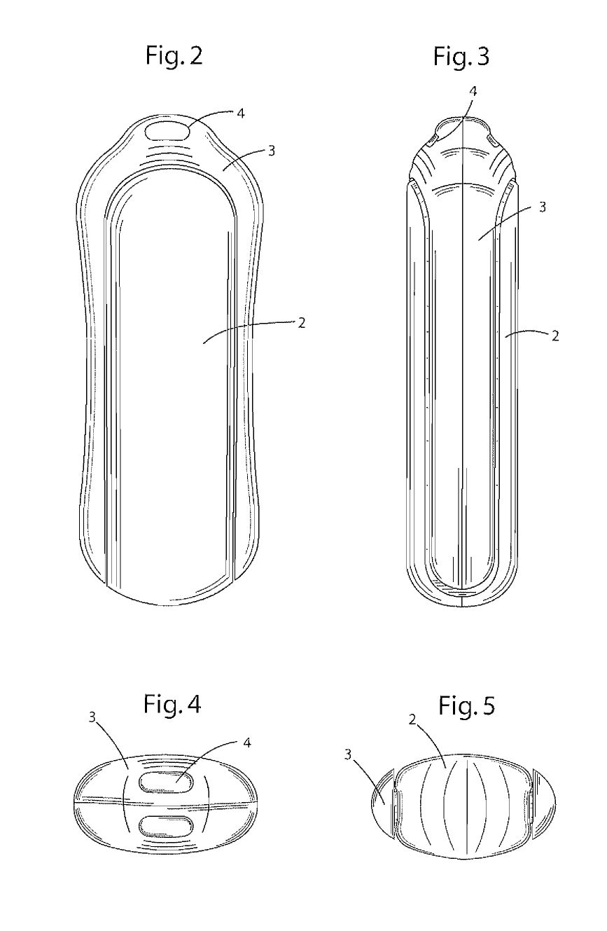

The confectionary holder of the present invention is shown in a closed position in which the hard candy is protected in FIGS. 1 through 5. Confectionary holder 1 has an outer housing consisting of slideable housing 2 and pivotable housing 3. The two housing sections are generally configured as two interlocking offset U-shapes to form a case around an interior space that contains the confectionary product. Pivotable housing 3 may optionally contain a through-hole 4 on its exterior surface. Through-hole 4 may be used to attach a strap or the like to the confectionary holder so that the confectionary holder may be worn by the user, for example, around the neck or wrist of the user. The surface of the confectionary holder may be smooth, textured to help a user grip the product or contain decorative features.

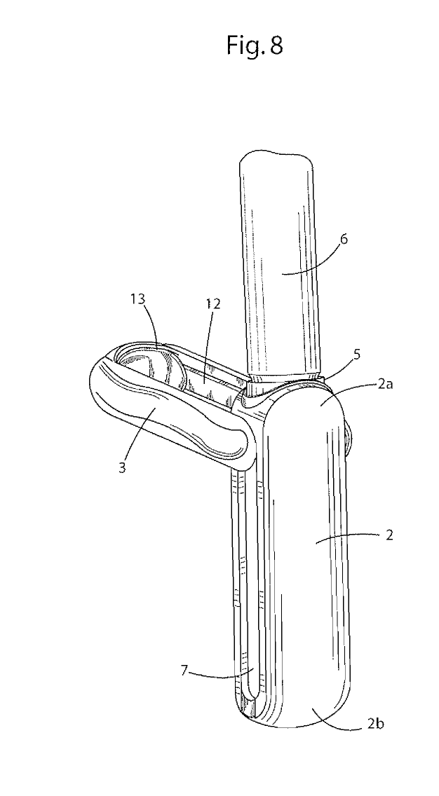

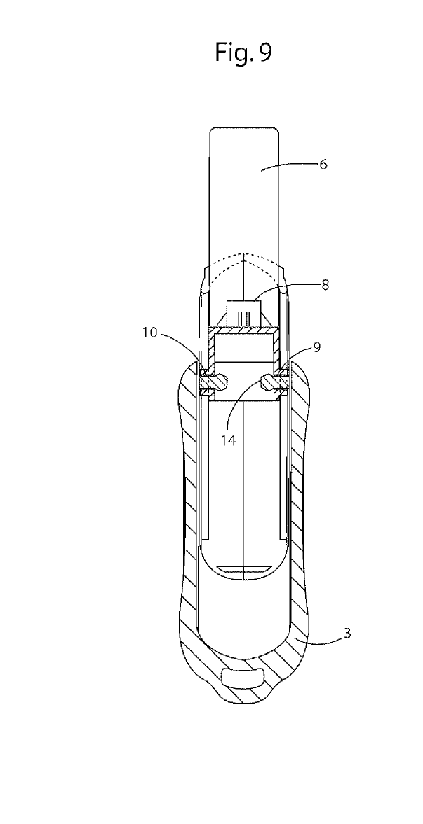

Slideable housing 2 contains first end 2A and second end 2B as shown in FIG. 8, and may be configured to contain confectionary mount 5. Confectionary mount 5 may be sized so as to fit within slideable housing 2 and move from first end 2A to second end 2B. In one embodiment, confectionary mount 5 loosely engages the inner wall of slideable housing 2 such that it can slide from one end to the other end of slideable housing 2. In another embodiment of the invention, on each side of slideable housing 2 are elongated slots 7 that extend from first end 2A to second end 2B. Although not shown in the figures, confectionary mount 5 may contain an extension that engages with elongated slots 7 so as to guide confectionary mount 5 in moving within slideable housing 2.

Pivotable housing 3 is pivotably mounted to confectionary mount 5 through elongated slots 7. Pivotable housing 3 may contain pins 9 that are inwardly disposed and opposite one another, as shown in FIG. 9. The pins may be inserted through pivot hole 10 within confectionary mount 5 to provide a pivotable connection between pivotable housing 3 and confectionary mount 5. The pins may contain deformable ends 14 such that when pins 9 are inserted through pivot holes 10, deformable ends 14 deform sufficiently so as to allow the pins to pass through pivot holes 10. After passing through the pivot holes, deformable ends 14 resume at least part of their enlarged configuration thereby holding the pivotable housing 3 in place. In another embodiment, a pin can be placed completely through confectionary mount 5. Any other suitable method of pivoting connection may be used. In one embodiment of the invention, pins 9 may engage elongated slots 7 of slideable housing 2 so as to guide confectionary mount 5 and act to prevent confectionary mount 5 from moving out of slideable housing 2.

A confection 6 may be mounted on confectionary mount 5. The confection may be stabilized on the confectionary mount by confectionary support block 8. The confection may be any type of hard candy or sucker-type candy, and may be any other type of confection that can be attached to the confection mount and held in the holder in both the open and closed positions. As an example, the confection may be a liquid-filled hard candy, a powder-filled hard candy, a chocolate-based confection or the like.

The slideable and pivotable housings 2, 3 and confectionary mount 5 may be made of any type of plastic, polymer, rubber or other suitable material or combination thereof using well-known manufacturing methods.

One example of the sliding and pivoting motion of the slideable and pivotable housings wherein the confectionary holder 1 is moved from the closed configuration to the open configuration is shown by the sequence in FIGS. 1, 6, 7, 8 and then 9. In FIG. 1, the confectionary holder is in the closed position. To open the holder, slideable and pivotable housings 2, 3 are biased by the user in opposite directions along their axes. This force causes confectionary mount 5 to slide within slideable housing 2 from second end 2B towards first end 2A, thereby starting to expose confectionary 6 which was contained within slideable and pivotable housings 2, 3. The full extension of pivotable housing 3 from slideable housing 2 is shown in FIG. 7. In one embodiment, pins 9 contact the end of elongated slot 7 and prevents any further separation of slideable and pivotable housings 2, 3.

The motion of pivotable housing 3 relative to slideable housing 2 may be limited by guide 12, as shown in FIG. 8, that is contained on the inside surface on one or both sides of pivotable housing 3. Guide 12 may be configured to engage with elongated slot 7 for the majority of the sliding engagement of confectionary mount 5 with slideable housing 2. In this embodiment, guide 12 would prevent the pivotal movement of pivotable housing 3 relative to slideable housing 2 until confectionary mount 5 substantially reaches first end 2A of slideable housing 2.

Once full extension is reached, pivotable housing 3 may then be pivoted around pins 9 to further expose confectionary 6. In another embodiment of the invention, the pivoting of pivotable housing 3 may occur in any slideable position of the slideable housing 2, or may occur in any slideable position except when confectionary mount 5 is at its two extreme positions within slideable housing 2, as further described below. FIG. 8 shows pivotable housing 3 pivoted backwards almost ninety degrees. The range of motion for pivotable housing 3 may be 360°, or a subset thereof. In one embodiment, pivotable housing 3 is rotated 180° and meshes with slideable housing 2 to form a holder for the user as shown in the cross-section of FIG. 9. In one embodiment, guide 12 may again engage elongated slot 7 to hold pivotable housing 3 firmly with respect to slideable housing 2 when pivotable housing 3 is rotated 180° and meshes with slideable housing 2 to form a holder for the user as shown in the cross-section of FIG. 9.

In another embodiment, first end 2A of slideable housing 2 contains rim 11. Rim 11 is configured to engage top inner edge 13 of pivotable housing 3 when the holder is in the closed position. The engagement of the rim with the inner edge prevents the holder from being opened through pivotal motion of pivotable housing 3 relative to slideable housing 2 when the holder is in the fully closed position. To engage the pivotal motion, slideable housing 3 must be slid slightly apart from pivotable housing 3 so that rim 11 disengages from top inner edge 13. A similar feature can be created on second end 2B of slideable housing 2 so that when the holder is in the open position as shown in FIG. 9, the slideable and pivotable housings 2, 3 are held pivotably firm relative to one another until they are slightly moved apart through the sliding motion.

As apparent, the holder of the present invention permits a user to expose a confectionary product, partially consume it, and then close the holder to protect the confectionary product from contamination. The present invention is not limited to hard candy confections, but may also apply to other confections that can be attached to a holder for consumption.

What is claimed is:

1. A holder for a confectionary product comprising:
a confectionary mount;
a slideable housing with a first end and a second end,
the slideable housing coupled to the confectionary mount wherein the housing may be moved from a position where the first end is adjacent to the confectionary mount to a position where the second end is adjacent to the confectionary mount;
a pivotable housing pivotably mounted to the confectionary mount; and
the slideable and pivotable housings forming a cavity for receiving the confectionary mount.

2. The holder for a confectionary product of claim 1 further comprising:
a confection mounted on the confectionary mount.

3. The holder for a confectionary product of claim 2, wherein the pivotable housing contains at least one guide that prevents the pivotable housing from pivoting relative to the slideable housing except when the confectionary mount is in a position substantially near the first end of the slideable housing.

4. The holder for a confectionary product of claim 2, wherein the pivotable housing is capable of pivoting 360 degrees around the confectionary mount.

5. The holder for a confectionary product of claim 2, wherein the pivotable housing can be pivoted at least 180 degrees around the confectionary mount and form, in conjunction with the slideable housing, a handle for holding the confection in a position for consumption.

6. The holder for a confectionary product of claim 2, wherein the slideable housing contains elongated slots extending from the first end to the second end of the slideable housing, with the pivotable housing mounted to the confectionary mount through the elongated slots.

7. The holder for a confectionary product of claim 1 further comprising:
a strap; and
a means for attaching the strap to the holder.

8. A holder for a confectionary product comprising:
a means for mounting a confectionary product;
a means for dispensing the confectionary product that is slideably and pivotably connected to the means for mounting the confectionary product; and
the means for dispensing the confectionary product further has a first position that encloses the confectionary product and a second position in which the confectionary product is capable of being consumed by a user.

9. The holder for a confectionary product of claim 8 further comprising:
a confection attached to the means for mounting the confectionary product.

10. The holder for a confectionary product of claim 9 wherein the means for dispensing the confectionary product has a means for limiting pivotal movement when in the second position.

11. A holder for a confectionary product comprising:
a confectionary mount;
a confection mounted on the confectionary mount;
a slideable housing slideably coupled to the confectionary mount;
a pivotable housing pivotably mounted to the confectionary mount; and
the slideable and pivotable housings are configured such that in one slideable and pivotable position combination a confectionary attached to the confectionary mount is substantially enclosed by the slideable and pivotable housings, and in another slideable and pivotable position combination the confectionary attached to the confectionary mount is capable of being consumed by a user.

12. The holder for a confectionary product of claim 11 further comprising:
elongated slots with the slideable housing, through which the pivotable housing is pivotably mounted to the confectionary mount.

13. The holder for a confectionary product of claim 11 further comprising:
a strap; and
an attachment feature on the second housing capable of affixing the strap to the second housing.
